(19) United States
(12) Patent Application Publication
(10) Pub. No.: US 2026/0126809 A1
(43) Pub. Date: May 7, 2026

(54) METHOD FOR EXTRICATING POOL CLEANING ROBOT FROM STUCK STATE AND THE CORRESPONDING POOL CLEANING ROBOT

(71) Applicant: Shenzhen Aiper Intelligent Co., Ltd., Shenzhen (CN)

(72) Inventors: Gujie Tang, Shenzhen (CN); Kai Zheng, Shenzhen (CN)

(21) Appl. No.: 19/022,208

(22) Filed: Jan. 15, 2025

(30) Foreign Application Priority Data
Nov. 5, 2024 (CN) 2024115652340

(51) Int. Cl. G05D 1/639; B63G 8/00; B63G 8/08; B63G 8/22; E04H 4/16; G05D 105/10; G05D 107/00

(52) U.S. Cl. CPC G05D 1/639; B63G 8/001; B63G 8/08; B63G 8/22; E04H 4/1654; G05D 2105/10; G05D 2107/29

(57) ABSTRACT

A method for extricating a pool cleaning robot from a stuck state and a corresponding pool cleaning robot. The method includes: controlling the pool cleaning robot to travel in a pool to perform a cleaning operation; acquiring an operating parameter or posture information of the pool cleaning robot during the traveling, and determining whether the pool cleaning robot is stuck due to being sucked according to the operating parameter or posture information; if it is determined that the pool cleaning robot is stuck due to being sucked, performing an extrication action; as example, the extrication action includes adjusting a magnitude and/or direction of the driving force of the pool cleaning robot.

### CROSS-REFERENCE

This application claims the priority of China Patent Application No. 2024115652340 filed on Nov. 5, 2024, the disclosure of which is considered as a part of the disclosure of this application and is hereby incorporated by reference.

### TECHNICAL FIELD

The present disclosure relates to the technical field of a pool cleaning robot, in particular to a method for extricating a pool cleaning robot from a stuck state and the corresponding pool cleaning robot.

### BACKGROUND

In recent years, with the progress of science and technology and the development of Internet, robot technology has become increasingly mature and been widely used in various fields of life. On the market, a large number of robots with various special purposes have emerged, among which swimming pool cleaning robots can do a lot of cleaning work for users and provide significant help. The pool cleaning robots can be used to clean the bottom and side walls of the swimming pool, such as removing the silt, dirt and algae, to keep the swimming pool clean.

### SUMMARY

The disclosure provides a method for extricating a pool cleaning robot from a stuck state and the corresponding pool cleaning robot; based on the method, it can be detected that the pool cleaning robot is stuck due to being sucked and the corresponding ability to extricate the pool cleaning robot from a stuck state can be improved.

In a first aspect, the present disclosure provides a method for extricating a pool cleaning robot from a stuck state, which comprises:
controlling the pool cleaning robot to travel in the pool to perform a cleaning operation;
acquiring an operating parameter or posture information of the pool cleaning robot during the traveling, and determining whether the pool cleaning robot is in a stuck state due to being sucked according to the operating parameter or posture information;
if determining the pool cleaning robot is stuck due to being sucked, performing an extrication action;
wherein, the extrication action comprises adjusting a magnitude and/or direction of a driving force of the pool cleaning robot.

In a second aspect, the present disclosure also provides a pool cleaning robot including:
a traveling mechanism configured to drive the pool cleaning robot to travel on a bottom or sidewall of the pool;
a water spraying mechanism configured to provide water thrust for the pool cleaning robot; and
a control mechanism configured to acquire an operating parameter or posture information of the pool cleaning robot in the traveling, to determine whether the pool cleaning robot is in a stuck state due to being sucked according to the operating parameter or posture information, and control the pool cleaning robot to perform an extrication action if it is determined the pool cleaning robot is in a stuck state due to being sucked, wherein the extrication action includes adjusting a magnitude and/or direction of the driving force.

### BRIEF DESCRIPTION OF THE DRAWINGS

FIGS. 1A-1B schematically illustrate an appearance of a pool cleaning robot according to the present disclosure.

FIG. 2 is a flow chart for illustrating a method for extricating a pool cleaning robot from a stuck state according to an embodiment of the present disclosure;

FIG. 3 is a flow chart for illustrating a method for extricating a pool cleaning robot from a stuck state according to an embodiment of the present disclosure;

FIG. 4 is a schematic structural diagram of a pool cleaning robot according to an embodiment of the present disclosure.

### DETAILED DESCRIPTION

The present disclosure will be further described in detail with the accompanying drawings and examples. It can be understood that the specific embodiments described herein are only used to explain the disclosure, and are not limited to the disclosure. In addition, it should be noted that, for the convenience of description, only some parts related to the present disclosure, but not all structures, are illustrated in the drawings.

Before discussing the exemplary embodiments in more detail, it should be noted that some exemplary embodiments are described as processes or methods depicted as flowcharts. Although the flowchart describes each step as a sequential process, many of the steps can be implemented in parallel, concurrently or simultaneously. In addition, the order of the steps can be rearranged. The process may be terminated when its operation is completed, but there may be additional steps not included in the drawings. A process may correspond to a method, a function, a procedure, a subroutine, a sub-computer program, and the like.

In addition, the terms “first”, “second” and the like can be used herein to describe various directions, actions, steps or elements, but these directions, actions, steps or elements are not limited by these terms. These terms are only used to distinguish one direction, action, step or element from another. For example, without departing from the scope of this application, the first information may be referred to as the second information, and similarly, the second information may be referred to as the first information. Both the first information and the second information are information, but they might not be the same information. The terms “first”, “second” and so on cannot be understood as indicating or implying relative importance or implicitly indicating the number of indicated technical features. Therefore, the features defined as “first” and “second” may include one or more of these features explicitly or implicitly. In the description of this disclosure, “plural” means at least two, such as two, three, etc., unless otherwise specifically defined.

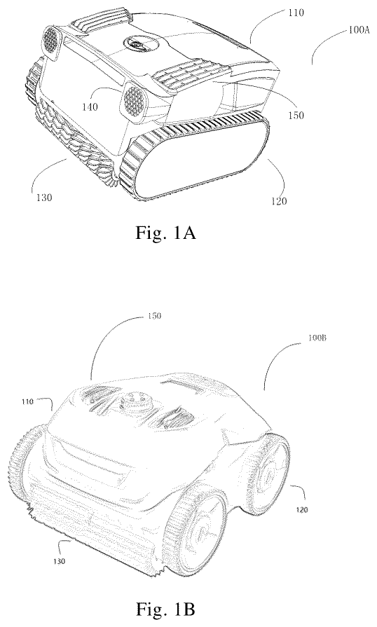

FIG. 1A schematically illustrates an appearance of a pool cleaning robot 100A according to an embodiment of the present disclosure. The pool cleaning robot 100A can clean the bottom, sidewalls, water therein and water surface of the pool (such as a swimming pool) as needed, for example, to clean the garbage in the water, on the bottom and the water surface, and clean the dirt on the bottom and walls of the pool. As illustrated in FIG. 1A, the pool cleaning robot 100 may include a housing 110, a traveling mechanism 120, a cleaning unit 130 and other structures/components. As an example, the pool cleaning robot 100 may further include a buoyancy adjusting unit (not illustrated), so that the pool cleaning robot can adjust its depth in the water as needed, for example, it can float on the water surface, dive into the water, and sink to the bottom of the water, so as to carry out the cleaning operation on the water surface, in the water or at the bottom of the water. As an example, a control bin, a power bin and a filter bin (not illustrated) can be arranged in the housing 100, wherein control circuits such as a microprocessor, a digital signal processor (DSP) and a microcontroller can be arranged in the control bin, a driving mechanism such as a water pump and a driving motor can be arranged in the power bin, and a filter unit can be arranged in the filter bin so as to filter and purify the water entering the filter bin through a water inlet, filter out impurities therein, and discharge the filtered water to the outside of the pool cleaning robot. As an example, the traveling mechanism 120 of the pool cleaning robot 100A illustrated in FIG. 1A is a crawler traveling mechanism, while the traveling mechanism 120 of the pool cleaning robot 100B illustrated in FIG. 1B is a wheeled traveling mechanism.

As an example, FIG. 1A also illustrates drainage outlets 140 symmetrically arranged on the rear side of the housing 110 of the pool cleaning robot 100 with respect to the longitudinal axis of the body of the pool cleaning robot, drainage outlets 150 symmetrically arranged on the top of the housing 110 with respect to the longitudinal axis of the body of the pool cleaning robot. Further, drainage outlets (not illustrated) can be symmetrically arranged on the front side of the housing 110 of the pool cleaning robot 100. As an example, the pool cleaning robot 100 can use the water spraying unit as an auxiliary traveling unit, so that the pool cleaning robot can be propelled to travel on the water surface, in the water, on the bottom and/or the side wall of the pool by a thrust generated from a water jet from a water spraying nozzle of the water spraying unit. In this case, the water jet from the water spraying nozzle can be guided to one of the drainage outlets provided on the housing 110 of the pool cleaning robot 100, thereby generating the thrust in different directions.

Although FIGS. 1A-1B illustrate the overall appearance of the pool cleaning robot according to the embodiment of the present disclosure. It should be understood that this is only schematic and does not constitute any limitation on the principles of the present disclosure.

As an example, the pool cleaning robot according to the present disclosure can be used to clean a swimming pool. Some swimming pools will be equipped with sand tanks, water purifiers and other filtration systems, and various drainage covers are arranged in the swimming pool. When the filtration system is in operation, the water is pumped out via the drainage outlet of the drainage cover, generating the high suction force. In the process of cleaning the bottom of the pool, the pool cleaning robot often traverses the drainage outlet of the drainage cover, and it is easy to be sucked by the drainage outlet, which causes the pool cleaning robot to be trapped and unable to move or travel, that is, the robot is stuck and cannot continue to perform the cleaning operation normally.

In view of the above, the present disclosure provides a pool cleaning robot and a control method, which can detect whether the pool cleaning robot is trapped due to being sucked, and extricate the pool cleaning robot if it is trapped due to being sucked.

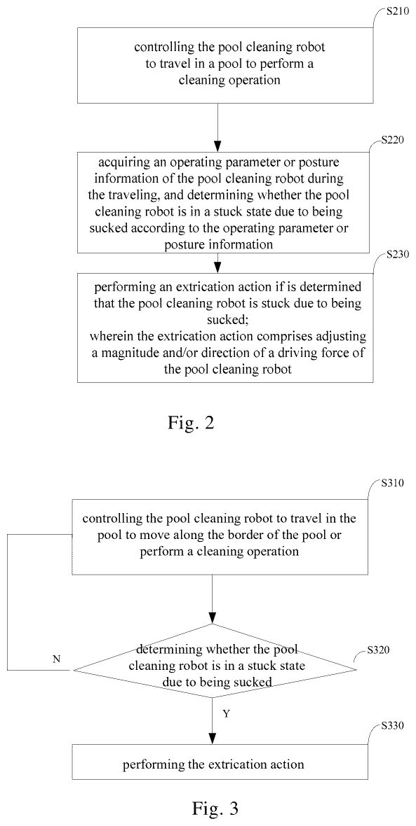

FIG. 2 schematically illustrates a method for extricating a pool cleaning robot from a stuck state according to an embodiment of the present disclosure, as illustrated in FIG. 2, which includes:
S210, controlling the pool cleaning robot to travel in the pool to perform the cleaning operation;
S220, in the traveling, obtaining the operating parameter or posture information of the pool cleaning robot, and determining whether the pool cleaning robot is in a stuck state due to being sucked according to the operating parameter or posture information;
S230, if it is determined that the pool cleaning robot is in a stuck state due to being sucked, performing an extrication action;
Wherein, the extrication action comprises adjusting a magnitude and/or direction of a driving force.

According to the above embodiments of the present disclosure, it can be detected the situation that the pool cleaning robot is stuck by suction, and the corresponding ability to extricate the pool cleaning robot from a stuck state can be improved.

In an optional embodiment, the operating parameter can include a current value of a driving motor of the traveling mechanism, and the posture information can include a yaw angle variation.

As an example, the traveling mechanism comprises wheels of the pool cleaning robot or wheels accompanying the tracks the cleaning robot.

As an example, determining whether the pool cleaning robot is in a stuck state due to being sucked according to the operating parameter or posture information comprises determining that the pool cleaning robot is in the stuck state due to being sucked if a preset condition is satisfied regarding the current value of the driving motor or the variation of the yaw angle. The stuck in this application refers to the state in which the pool cleaning robot is trapped due to being sucked and unable to move during the underwater travel.

In an optional embodiment, the preset condition includes:
within a preset first period, that an average value or maximum value of the current of the drive motor being greater than a preset current threshold value; or
within a preset second period, that the variation of the yaw angle being less than a preset angle threshold.

According to the above embodiments of the present disclosure, if the pool cleaning robot is in the stuck state due to being sucked, the load of the wheel will be changed compared to that in the normal travel and the pool cleaning robot cannot move, and thus it can be determined whether the pool cleaning robot is in the stuck state due to being sucked by monitoring the change of the current of the driving motor and/or the yaw angle of the pool cleaning robot.

In an optional embodiment, the driving force includes at least one of the water thrust from the water spraying mechanism, the thrust from the traveling mechanism and the buoyancy of the pool cleaning robot.

In an optional embodiment, the extrication action includes: adjusting the buoyancy of the robot, so that the pool cleaning robot moves upwards to get out of the stuck state by the buoyancy.

According to the above embodiment of the present disclosure, the pool cleaning robot moves upwards by the buoyancy to get out of the stuck state.

In an optional embodiment, performing the extrication action includes performing at least one of a first extrication action, a second extrication action and a third extrication action.

In an optional embodiment, if the pool cleaning robot is in a stuck state due to being sucked, performing the extrication action includes:
performing a first extrication action;
If the pool cleaning robot is still in the stuck state due to being sucked after performing the first extrication action for a preset first number of times, performing the second extrication action;
If the pool cleaning robot is still in the stuck state due to being sucked after performing the second extrication action for a preset second number of times, performing the third extrication action; and
If the pool cleaning robot is still in the stuck state due to being sucked after performing the third extrication action for the preset third number of times, an alarm is generated.

According to the above embodiments of the present disclosure, the possibility of extricating the pool cleaning robot from the stuck state is increased by attempting different extrication actions for many times. If the pool cleaning robot cannot be extricated from the stuck state after the attempts, the alarm information can be generated and reported to the user so as to inform the user to assist the pool cleaning robot in getting out of the stuck state.

In an optional embodiment, the first extrication action includes:
adjusting a magnitude of water thrust from the water spraying mechanism; or
adjusting the magnitude of the water thrust from the water spraying mechanism and adjust the magnitude and/or direction of the thrust from the traveling mechanism.

The water spraying mechanism described in this application includes a water pump of the pool cleaning robot, and the water pump is used to guide water to enter from the water inlet at the bottom of the pool cleaning robot, pass through the filter inside the pool cleaning robot, and then be discharged to the outside of the pool cleaning robot from the top or side drainage outlet(s) of the pool cleaning robot.

If the water spraying mechanism includes a water pump, by reducing the water thrust from the water spraying mechanism or directly turning off the water pump, the pressure generated by the water flowing out of the drainage outlet can be reduced, thereby reducing the suction force; In addition, it can also reduce the friction between the pool cleaning robot and the supporting surface, thus increasing the traveling speed of the pool cleaning robot.

The water spraying mechanism can also include a water spraying propulsion mechanism independent of the water pump and the drainage outlet, which can increase the driving force of the pool cleaning robot. If it is necessary to change the direction of the water thrust from the water spraying mechanism, it can be achieved by changing the rotation direction of the blades of the water spraying propulsion mechanism, rotating the conduit(s) of the water spraying mechanism or switching the drainage outlets at different positions so as to change the direction of the waterflow.

By increasing the thrust from the traveling mechanism and controlling the pool cleaning robot to travel in different directions, the traveling speed of the pool cleaning robot can be further improved and the possibility of getting out of trouble can be improved.

In an optional embodiment, the second extrication action includes:
adjusting the direction of the water thrust from water spraying mechanism; or
adjusting the direction of the water thrust from the water spraying mechanism and adjust the magnitude and/or direction of the thrust from the traveling mechanism.

According to the above embodiment of the present disclosure, the direction of water thrust from the water spraying mechanism can be adjusted from the direction toward the top of the pool cleaning robot to the direction opposite to the traveling direction of the pool cleaning robot, so that the downward pressure generated by the water spraying mechanism toward the bottom and/or sidewall of the pool can be reduced, and the traveling speed of the pool cleaning robot can be increased; by increasing the magnitude of the thrust from the traveling mechanism and controlling the pool cleaning robot to travel in different directions, the traveling speed of the pool cleaning robot can be further increased and the possibility of getting out of the stuck state can be increased.

In an optional embodiment, the third extrication action includes:
adjusting the direction and magnitude of the water thrust from the water spraying mechanism; or
adjusting the direction and magnitude of the water thrust from the water spraying mechanism and adjust the magnitude and/or direction of the thrust from the traveling mechanism. In an optional embodiment, if the direction of the driving force of the traveling mechanism, such as wheels, is adjusted, the direction can be continuously adjusted, so that the pool cleaning robot travels along a curve.

From the above description, it can be seen that the traveling speed of the pool cleaning robot can be increased by adjusting the direction of the water thrust from the water spraying mechanism to the direction opposite to the traveling direction of the pool cleaning robot and increasing the magnitude of the water thrust from the water spraying mechanism; by increasing the magnitude of the thrust from the traveling mechanism and controlling the pool cleaning robot to move and rotate in different directions, the traveling speed of the pool cleaning robot can be further increased and the possibility of getting out of the stuck state can be increased.

In an optional embodiment, before performing the extrication action, the method further comprises:
determining whether the pool cleaning robot is close to the sidewall of the pool, for example, determining whether the front end or the rear end of the pool cleaning robot is close to the sidewall of the pool through a ranging sensor arranged on the front or the rear end of the pool cleaning robot;
if it is determined that the pool cleaning robot is close to the sidewall of the pool, controlling the pool cleaning robot to rotate by a preset angle, and then performing the extrication action to avoid colliding with the sidewall of the pool in the extrication process.

As can be seen from the above description, if the pool cleaning robot approaches the sidewall of the pool, the pool cleaning robot is controlled to rotate first, and then the extrication action is performed, so as to prevent the pool cleaning robot from hitting the sidewall of the pool during the extrication action, thus ensuring the safety of the pool cleaning robot.

The present disclosure also provides a pool cleaning robot, which includes:
a filter configured to filter the water entering the pool cleaning robot;
a traveling mechanism configured to drive the pool cleaning robot to travel on a supporting surface;
a water spraying mechanism configured to provide water thrust for the pool cleaning robot;
one or more processors; and
storage apparatus configured to store one or more programs;
when the one or more programs are executed by the one or more processors, the pool cleaning robot can perform the above extrication method.

FIG. 3 illustrates a method for extricating a pool cleaning robot from a stuck state, which comprises the following steps:
S310: controlling the pool cleaning robot to travel in the pool to move along the border of the pool or perform a cleaning operation.
S320: during the traveling, determining whether the pool cleaning robot is in a stuck state due to being sucked, if so, performing the step S330; otherwise, controlling the pool cleaning robot to continue to move along the border or perform the cleaning operation.

In some optional embodiments, it is determined whether the pool cleaning robot is in a stuck state due to being sucked according to the operating parameter of the pool cleaning robot during the traveling. Specifically, during the traveling, the operating parameter of the pool cleaning robot is obtained, and if the preset condition is satisfied regarding the operating parameter, it is determined that the pool cleaning robot is in a stuck state due to being sucked. In an optional embodiment, the operating parameter includes a current value of the driving motor of the traveling mechanism, and the preset condition includes the average or maximum value of the current value of the driving motor within a preset first period being greater than a preset current threshold, wherein the preset current threshold can be a fixed value or can be determined based on the current of the driving motor when the pool cleaning robot travels normally. For example, the current of the drive motor is obtained at a certain frequency and filtered; and if the pool cleaning robot is in a normal travelling state, the current of the drive motor is substantively constant; and if the pool cleaning robot is sucked, the load will increase and the current of the drive motor will be changed significantly compared to those in the normal travel. Therefore, if the average value of the current of the drive motor in a period of time is greater than a preset current threshold, it is determined that the pool cleaning robot is in a stuck state due to being sucked. It should be pointed out that the current value of the driving motor referred to in this application is the current value which excludes the abnormal data.

In some optional embodiments, it is determined whether the pool cleaning robot is in a stuck state due to being sucked according to the posture information of the pool cleaning robot during the traveling. Specifically, during the traveling, the posture information of the pool cleaning robot is obtained, and if the preset condition is satisfied regarding the posture information, it is determined that the pool cleaning robot is in a stuck state due to being sucked. In an optional embodiment, the posture information includes the variation of a yaw angle, and the preset condition include the variation of a yaw angle within a preset second period being less than a preset angle threshold. It should be pointed out that the variation of a yaw angle detected in this application is calculated based on the yaw angle value excluding the abnormal data.

As an example, if the pool cleaning robot is in a normal traveling state or in a non-stuck state, the pool cleaning robot will slip underwater, resulting in a variation in yaw angle, for example, from 0 degree to 5 degree. If the pool cleaning robot travels normally, the pool cleaning robot will automatically adjust the angle. Since the yaw angle provided by an Inertial Measurement Unit (IMU) is relatively accurate, the variation of a yaw angle can be detected by the IMU to determine whether the pool cleaning robot has slipped. If no slipping, it is determined that there is a stuck due to being sucked, and in such a case, the yaw angle detected by the IMU will remain unchanged for a long time or the variation is small.

At S330, the method comprises performing the extrication action. The extrication action includes adjusting the magnitude and direction of the driving force, which includes at least one of the water thrust from the water spraying mechanism, the thrust from the traveling mechanism and the buoyancy of the pool cleaning robot. Since the extrication action has already been described above, it will not be repeated herein.

Further, in some embodiments, the method further comprises controlling the pool cleaning robot to search for the sidewall of the pool or continue to perform the cleaning operation after the extrication operation is completed and successful.

Further, if the pool cleaning robot is still stuck after the above extrications are performed, it means that the pool cleaning robot cannot be extricated from the stuck state due to being sucked by itself due to the strong suction of the drainage outlet, and an alarm message needs to be reported to the user via an application terminal to inform the user that the extrication failed and it needs the help from the user to extricate the pool cleaning robot from the stuck state.

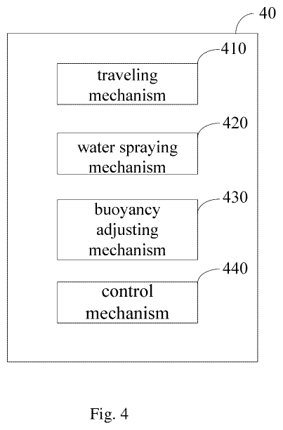

FIG. 4 illustrates a pool cleaning robot including:
a traveling mechanism 410 configured to drive the pool cleaning robot to travel on the pool bottom or the sidewall of the pool;
a water spraying mechanism 420 configured to provide water thrust for the pool cleaning robot; and
a control mechanism 440 configured to acquire the operating parameter or posture information of the pool cleaning robot during the traveling, and determine whether the pool cleaning robot is stuck due to being sucked according to the operating parameter or posture information, and control the pool cleaning robot to perform an extrication action if the pool cleaning robot is in a stuck state due to being sucked, wherein the extrication action includes adjusting the magnitude and/or direction of the driving force.

As an example, the pool cleaning robot may further include a filter that filters the water entering the pool cleaning robot and discharges the filtered water into the pool.

As an example, the traveling mechanism 410 may include a wheeled traveling mechanism or a crawler traveling mechanism. For example, the traveling mechanism 410 may include a driving motor(s) that drives the wheels of the wheeled traveling mechanism to travel and/or a driving motor(s) that drives the driving wheels of the crawler traveling mechanism.

As an example, adjusting the magnitude of the thrust from the traveling mechanism may include, but is not limited to, adjusting the driving current, driving torque, and/or driving power of the driving motor for driving the left and/or right wheels of the pool cleaning robot; adjusting the direction of the thrust from the traveling mechanism can include, but is not limited to, adjusting the speed difference between the left and right wheels of the pool cleaning robot, so that the direction of the resultant force of the thrust generated by the traveling mechanism changes; or when adjusting the direction of the driving force of the traveling mechanism, such as wheels, the direction can be continuously adjusted, so that the pool cleaning robot can travel along a curve.

As an example, the water spraying mechanism 420 may include a water pump, water spraying nozzles and/or at least two drainage outlets arranged on the housing of the pool cleaning robot. For example, the water pump sucks water from the pool and ejects the filtered water to the pool through the corresponding water spraying nozzles, providing the water thrust for the pool cleaning robot. As an example, the water spraying nozzles may include vector water spraying nozzles that can change the water spraying direction; or the water ejected from the water spraying nozzle can be guided to the drainage outlets at different positions arranged on the housing of the pool cleaning robot and discharged from the pool cleaning robot to the pool.

As an example, adjusting the water thrust from the water spraying mechanism may include, but is not limited to, adjusting at least one of the output power of the water pump, the water flow rate and/or the water flow speed of the water spraying mechanism; adjusting the direction of the water thrust from the water spraying mechanism may include, but is not limited to, adjusting the water spraying direction of the water spraying nozzle of the water spraying mechanism, such as rotating the water spraying nozzle; guiding the water flow ejected from the water spraying nozzle of the water spraying mechanism to the drainage outlets arranged at different positions on the housing of the pool cleaning robot; changing the rotating direction of the propeller blades of the water spraying mechanism; or a diversion pipe of the water spraying mechanism is rotated to switch the water spraying nozzles of the water spraying mechanism towards the drainage outlets at different positions.

As an example, the pool cleaning robot may further include a buoyancy adjusting mechanism 430 configured to adjust the buoyancy of the pool cleaning robot in water; wherein, the buoyancy of the pool cleaning robot can be adjusted by the buoyancy adjusting mechanism, so that the pool cleaning robot moves upwards to get out of the stuck state.

As an example, the buoyancy adjusting mechanism 430 may include an air pump and an air storage chamber. For example, the buoyancy of the pool cleaning robot in the water can be adjusted by pumping the air into the air storage chamber by the air pump or discharging at least a part of the air in the air storage chamber.

As an example, the control mechanism 440 may include one or more processors and a storage apparatus for storing instructions, and when the one or more processors execute the instructions, the pool cleaning robot is caused to perform the above extrication method described in connection with FIGS. 2-3.

According to the above embodiments of the present disclosure, it is detected whether the pool cleaning robot is in a stuck state due to being sucked by acquiring the operating parameter or posture information of the pool cleaning robot during the traveling, and if it is detected that the pool cleaning robot is in the stuck state due to being sucked, the pool cleaning robot is extricated by adjusting the driving force. Therefore, the method and the pool cleaning robot provided by the present disclosure can efficiently detect the stuck state of the pool cleaning robot, increasing the ability of the pool cleaning robot to get out of the stuck state.

From the above description of the embodiments, it can be clearly understood by those skilled in the art that the present disclosure can be realized by software and necessary general hardware, and it can also be fully realized by hardware. According to the embodiments of the disclosure, the storage apparatus includes a computer-readable storage medium, such as a computer floppy disk, a Read-Only Memory (ROM), a Random Access Memory (RAM), FLASH memory, hard disk or optical disk, etc.

It is noted that in the above embodiments, several units and modules therein is divided according to functional logic, but it is not limited to the above division; in addition, the specific names of functional units/modules are only for the convenience of distinguishing from each other, and are not used to limit the protection scope of this disclosure. The combination or substitution of any technical features in the above embodiments is included in the patent protection scope of this disclosure.

The above is only the embodiment of the disclosure, which does not limit the patent scope of the disclosure in any way. Any equivalent transformation made based on the contents of the specification and accompanying drawings of the disclosure, are equally included in the patent protection scope of the disclosure.

What is claimed is:

1. A method for extricating a pool cleaning robot from a stuck state, comprising:
controlling the pool cleaning robot to travel in a pool to perform a cleaning operation;
acquiring an operating parameter or posture information of the pool cleaning robot during the traveling, and determining whether the pool cleaning robot is in a stuck state due to being sucked according to the operating parameter or posture information; and
performing an extrication action in response to determining that the pool cleaning robot is in the stuck state due to being sucked;
wherein the extrication action comprises at least one of adjusting a magnitude direction of a driving force of the pool cleaning robot or adjusting a direction of the driving force.

2. The method according to claim 1, wherein the operating parameter comprises a current value of a driving motor of a traveling mechanism of the pool cleaning robot, and the posture information comprises a variation of a yaw angle of the pool cleaning robot;
wherein it is determined that the pool cleaning robot is in the stuck state due to being sucked if a preset condition is satisfied regarding at least one of the current value of the driving motor or the variation of the yaw angle.

3. The method according to claim 2, wherein the preset condition comprises at least one of:
the current value of that drive motor being greater than a preset current threshold; or
the variation of the yaw angle being less than a preset angle threshold.

4. The method according to claim 3, wherein the current value of the driving motor comprises a maximum current value or an average current value within a preset first period, and the variation of the yaw angle comprises the variation of the yaw angle within a preset second period.

5. The method according to claim 1, wherein the driving force comprises at least one of water thrust from a water spraying mechanism of the pool cleaning robot, thrust from a traveling mechanism of the pool cleaning robot and buoyancy of the pool cleaning robot.

6. The method according to claim 5, wherein the extrication action comprises: adjusting the buoyancy of the pool cleaning robot so that the pool cleaning robot moves upwards to get out of the stuck state.

7. The method according to claim 5, wherein the water spraying mechanism comprises a water pump, and the water pump is configured to guide water to enter the pool cleaning robot via a water inlet at a bottom of the pool cleaning robot, to be filtered via a filter inside the pool cleaning robot, and be discharged to outside of the pool cleaning robot.

8. The method according to claim 7, wherein adjusting the driving force comprises adjusting a power of the water pump to zero.

9. The method according to claim 5, wherein performing the extrication action comprises performing at least one of a first extrication action, a second extrication action or a third extrication action.

10. The method according to claim 9, wherein the first extrication action comprises at least one of:
adjusting a magnitude of the water thrust; or
adjusting the magnitude of the water thrust and adjusting a magnitude and/or direction of the thrust from the traveling mechanism;
the second extrication action comprises at least one of:
adjusting the direction of water thrust; or
adjusting the direction of the water thrust and adjusting the magnitude and/or direction of the thrust from the traveling mechanism;
and the third extrication action comprises at least one of:
adjusting the direction and magnitude of the water thrust; or
adjusting the direction and magnitude of the water thrust and adjusting the magnitude and/or direction of the thrust from the traveling mechanism.

11. The method according to claim 10, wherein if it is determined that the pool cleaning robot is in the stuck state due to being sucked, performing the extrication action comprises:
performing the first extrication action;
if performing the first extrication action fails to extricate the pool cleaning robot from the stuck state due to being sucked, performing the second extrication action;
if performing the second extrication action fails to extricate the pool cleaning robot from a stuck state due to being sucked, performing the third extrication action;
if performing the third extrication action fails to extricate the pool cleaning robot from a stuck state due to being sucked, generating an alarm.

12. The method according to claim 11, wherein adjusting the direction of the thrust from the traveling mechanism comprises continuously adjusting the direction.

13. The method according to claim 1, wherein before performing the extrication action, the method further comprises:
determining whether a front or rear end of the pool cleaning robot is close to a sidewall of the pool;
if it is determined that the pool cleaning robot is close to the sidewall of the pool, controlling the pool cleaning robot to rotate by a preset angle, and then performing the extrication action.

14. A pool cleaning robot comprising:
a traveling mechanism configured to drive the pool cleaning robot to travel on a bottom or sidewall of the pool;
a water spraying mechanism configured to provide water thrust to the pool cleaning robot; and
a control mechanism configured to acquire an operating parameter or posture information of the pool cleaning robot during the traveling, determine whether the pool cleaning robot is in a stuck state due to being sucked according to the operating parameter or posture information, and control the pool cleaning robot to perform an extrication action in response to determining that the pool cleaning robot is in the stuck state due to being sucked, wherein the extrication action comprises at least one of adjusting a magnitude direction of a driving force of the pool cleaning robot or adjusting a direction of the driving force.

15. The pool cleaning robot according to claim 14, wherein the operating parameter comprises a current value of a driving motor of the traveling mechanism of the pool cleaning robot, and the posture information comprises a variation of a yaw angle of the pool cleaning robot;
wherein the control mechanism is further configured to determine that the pool cleaning robot is in a stuck state due to being sucked if a preset condition is satisfied regarding at least one of the current value of the driving motor or the variation of the yaw angle.

16. The pool cleaning robot according to claim 15, wherein the preset condition comprises:
the current value of that drive motor being greater than a preset current threshold, or the variation of the yaw angle being less than a preset angle threshold.

17. The pool cleaning robot according to claim 14, wherein the driving force comprises at least one of water thrust from the water spraying mechanism of the pool cleaning robot, thrust from the traveling mechanism and buoyancy of the pool cleaning robot.

18. The pool cleaning robot according to claim 17, further comprising:
a buoyancy adjusting mechanism configured to adjust the buoyancy of the pool cleaning robot in the water, so that the pool cleaning robot moves upwards to get out of the stuck state.

19. The pool cleaning robot according to claim 14, further comprising a filter, wherein the water spraying mechanism comprises a water pump, and the water pump is configured to guide water to enter the pool cleaning robot via a water inlet at a bottom of the pool cleaning robot, to be filtered via the filter, and be discharged to outside of the pool cleaning robot via a drainage outlet arranged on a top or side of the pool cleaning robot.

20. The pool cleaning robot according to claim 19, wherein adjusting the water thrust from the water spraying mechanism comprises adjusting a power of the water pump.
